(19) United States
(12) Patent Application Publication
(10) Pub. No.: US 2013/0149025 A1
(43) Pub. Date: Jun. 13, 2013

(54) TELESCOPING MECHANISM

(71) Applicant: QING-SONG WEN, Shenzhen (CN)

(72) Inventor: QING-SONG WEN, Shenzhen (CN)

(21) Appl. No.: 13/707,915

(22) Filed: Dec. 7, 2012

(30) Foreign Application Priority Data
Dec. 10, 2011 (CN) 201120518113.2

(51) Int. Cl. F16B 7/10

(52) U.S. Cl. CPC F16B 7/105
USPC 403/109.3

(57) ABSTRACT

A telescoping mechanism includes a base, a movable member, a support member, and a resisting assembly. The base defines a receiving groove. The movable member is slidably connected to and opposes the base. The support member is rotatably connected with the base. The support member includes a first support portion engaged in the receiving groove and a second support portion connected with the first support portion. The second support portion defines an engaging groove. The resisting assembly is mounted on the second support portion. To lift the movable member, the first support portion is lifted and resists against the movable member, and after the movable member is brought down to the base, the movable member latches in the engaging groove, and the resisting assembly resists against the movable member.

### BACKGROUND

1. Technical Field

The present disclosure generally relates to telescoping mechanisms.

2. Description of the Related Art

A telescoping mechanism may be controlled by a plurality of cylinders, such that the telescoping mechanism is stably locked after lifting, and tightly pressed together after descending. However, such telescoping mechanism has a complicated structure and an inconvenient operation. In addition, a controller for electricity and gas is required, so that a cost of the telescoping mechanism is relatively high.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric, assembled view of an embodiment of a telescoping mechanism.

FIG. 2 is an isometric, assembled view of the telescoping mechanism of FIG. 1 in a lifted state.

FIG. 3 is an isometric, assembled view of the telescoping mechanism of FIG. 1 in a descended state.

### DETAILED DESCRIPTION

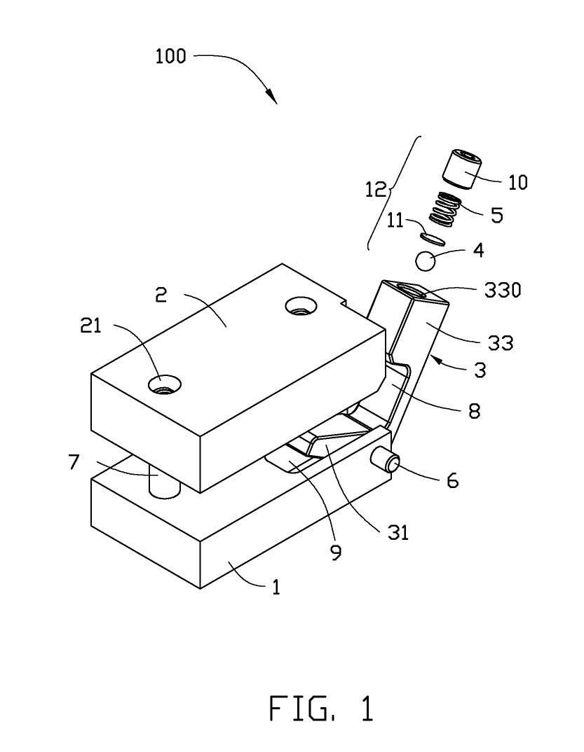

Referring to FIGS. 1 through 3, an embodiment of a telescoping mechanism 100 includes a base 1, a movable member 2, a support member 3, two guiding shafts 7, a rotating shaft 6, and a resisting assembly 12.

The base 1 and the movable member 2 are substantially rectangular blocks. A receiving groove 9 is defined in a surface of the base 1 facing the movable member 2. Two sliding holes 21 are defined in the movable member 2. The support member 3 is substantially L-shaped, includes a first support portion 31 and a second support portion 33 substantially perpendicularly connected to the first support portion 31. The first support portion 31 is received in the receiving groove 9, and is rotatable relative to the base 1 via the rotating shaft 6. The first support portion 31 includes a resisting surface 311 adjacent to the movable member 2. The resisting surface 311 is a curved surface. An engaging groove 8 is defined in a side surface of the second support portion 33 adjacent to the first support portion 31. A width of the engaging groove 8 is such that the thickness of the movable member 2 can be accommodated and latched within the engaging groove 8. A chamfer angle 81 is defined on a side surface of the engaging groove 8 away from the first support portion 31. A through hole 330 is defined in one end of the second support portion 33 along a length-wise direction of the second support portion 33. The resisting assembly 12 is mounted in the through hole 330. The two guiding shafts 7 are mounted on opposite ends of a surface of the base 1 facing the movable member 2, corresponding to the two sliding holes 21 in the movable member 2, such that the movable member 2 is slidable along the guiding shafts 7. The resisting assembly 12 includes a resisting ball 4, a washer 11, an elastic member 5 and a nut 10. The resisting ball 4, the washer 11, the elastic member 5 and the nut 10 are mounted in that order in the through hole 330. A diameter of the resisting ball 4 is greater than a diameter of one end of the through hole 330 adjacent to the first support portion 31, such that a part of the resisting ball 4 protrudes out from the through hole 330.

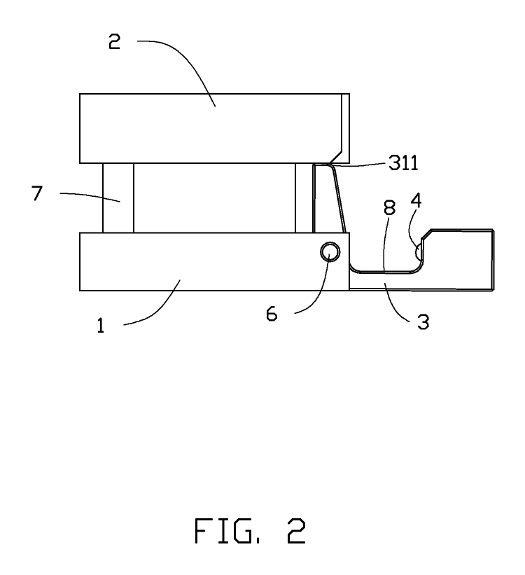

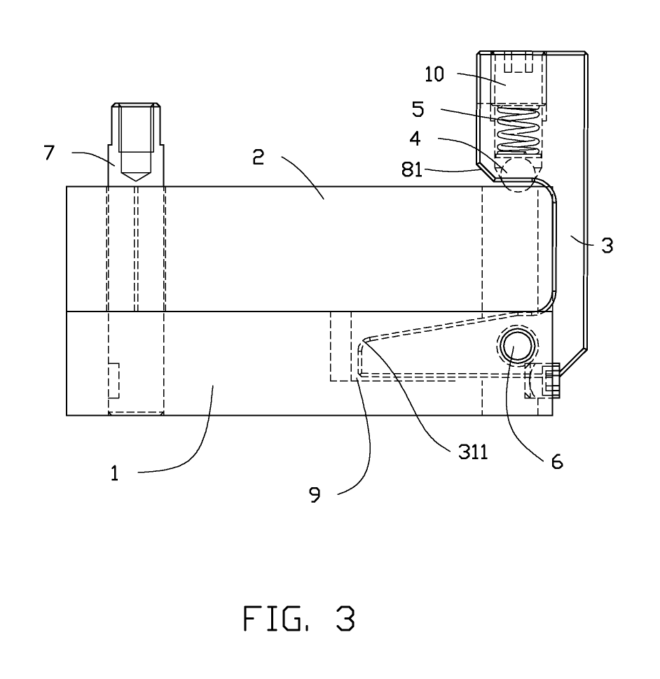

In use as a compressing or telescoping mechanism, when the movable member 2 (see FIG. 2) is lifted, the support member 3 rotates in a clockwise direction through 90 degrees, the first support portion 31 lifts the movable member 2 along the guiding shafts 7, and the resisting surface 311 resists against the movable member 2. The first support portion 31 then holds the movable member 2 a precise distance immediately above the base 1. To bring down the movable member 2 (see FIG. 3), the support member 3 is rotated 90 degrees in a counterclockwise direction, the first support portion 31 is received in the receiving groove 9, the movable member 2 is latched in the engaging groove 8, and the resisting ball 4 resists against the movable member 2. The movable member 2 is then held a precise distance, or no distance, above the base 1.

In the illustrated embodiment, the resisting ball 4 is made of steel. In other embodiments, the resisting ball 4 can be made of other materials, such as metal or plastic. The elastic member 5 is a compression spring.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A telescoping mechanism, comprising:
a base defining a receiving groove;
a movable member facing the base and slidably connected with the base;
a support member rotatably connected with the base, the support member comprising a first support portion engaged in the receiving groove and a second support portion connected with the first support portion, the second support portion defining an engaging groove; and
a resisting assembly mounted in the second support portion, wherein when the movable member is lifted, the first support portion lifts and resist against the movable member, and when the movable member is brought down, the movable member is latched in the engaging groove, and the resisting assembly resists against the movable member.

2. The telescoping mechanism of claim 1, wherein the second support portion defines a through hole, and the resisting assembly is mounted in and partly protrudes out from the through hole.

3. The telescoping mechanism of claim 2, wherein the resisting assembly comprises a resisting ball and an elastic member resisting against the resisting ball, and when the movable member is descended, the resisting ball protrudes out from the through hole and resists against the movable member.

4. The telescoping mechanism of claim 1, wherein the telescoping mechanism further comprises a guiding shaft, the guiding shaft is mounted on the base, and a sliding hole is defined in the movable member corresponding to the guiding shaft, such that the movable member is movable along the guiding shaft.

5. The telescoping mechanism of claim 1, wherein the first support portion comprises a resisting surface facing the movable member, and the resisting surface is a curved surface.

6. The telescoping mechanism of claim 1, wherein a thickness of the movable member can be accommodated and latched within the engaging groove.

7. The telescoping mechanism of claim 1, wherein a chamfer angle is defined on a side surface of the engaging groove away from the first support portion.

8. A telescoping mechanism, comprising:
a base defining a receiving groove;
a movable member facing the base and slidably connected with the base;
a support member rotatably connected with the base, the support member comprising a first support portion engaged in the receiving groove and a second support portion connected with the first support portion, the second support portion defining an engaging groove and a through hole; and
a resisting assembly mounted in the through hole, the resisting assembly comprising a resisting ball and an elastic member resisting against the resisting ball, wherein when the movable member is lifted, the first support portion lifts and resist against the movable member, and when the movable member is brought down, the movable member is latched in the engaging groove, and the resisting ball resists against the movable member.

9. The telescoping mechanism of claim 8, wherein the resisting assembly further comprises a washer sandwiched between the resisting ball and the elastic member.

10. The telescoping mechanism of claim 8, wherein the resisting ball is made of steel.

11. The telescoping mechanism of claim 8, wherein the telescoping mechanism further comprises a guiding shaft, the guiding shaft is mounted on the base, and a sliding hole is defined in the movable member corresponding to the guiding shaft, such that the movable member is movable along the guiding shaft.

12. The telescoping mechanism of claim 8, wherein the first support portion comprises a resisting surface facing the movable member, and the resisting surface is a curved surface.

13. The telescoping mechanism of claim 8, wherein a thickness of the movable member can be accommodated and latched within the engaging groove.

14. The telescoping mechanism of claim 8, wherein a chamfer angle is defined on a side surface of the engaging groove away from the first support portion.
